(19) United States
(12) Patent Application Publication
(10) Pub. No.: US 2003/0009371 A1
(43) Pub. Date: Jan. 9, 2003

(54) Interactive decision-making scenarios in an audio/video broadcast

(76) Inventors: Ravi Gauba, Fremont, CA (US); Klaus Hofrichter, Santa Clara, CA (US); Annie Wang, San Jose, CA (US); Richter A. Rafey, Santa Clara, CA (US); Clement Lau, Los Altos, CA (US)

Correspondence Address: Florin Corie, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/898,600

(22) Filed: Jul. 3, 2001

(51) Int. Cl. G06F 17/60

(52) U.S. Cl. 705/10

(57) ABSTRACT

Interactive decision-making scenarios in an audio/video broadcast are described. A profile of a user and content information associated with a selected content file are retrieved in response to a selection input command from the user, the selection input command selecting the content file for transmission to the user. A play sequence of the content file is further selected based on the user profile and the content information. Finally, the selected play sequence is presented to the user.

### FIELD OF THE INVENTION

The present invention relates generally to data communications and, more particularly, to interactive decision-making scenarios in an audio/video broadcast.

### BACKGROUND

Current audio/video broadcasts do not allow viewers any interaction with programs broadcasted by content providers, for example television networks and cable channel providers, or with the advertisements presented on the viewers' television sets. Whether viewers like or dislike the outcome of the programs they watch, they cannot influence that outcome and cannot filter or restrict the constant flow of advertisements presented by the content providers.

Even if viewer interaction with broadcasted programs and/or advertisements is limited, in other areas, interactive solutions have been devised to allow some level of user interaction. But these interactions are also narrow in scope and do not provide feedback based on the users' past actions and viewing habits.

For example, in the optical recording area, audio/video programs, for example motion pictures, may include multiple alternate plots and endings, which are previously recorded on the various available optical media. Using prerecorded interactive menus, viewers are prompted to choose between the alternate plots and endings when viewing the programs.

Similarly, in the video or computer games area, users may interact with certain aspects of the video or computer games, and may choose to interact with characters within the games using predetermined pop-up menus.

### SUMMARY

Interactive decision-making scenarios in an audio/video broadcast are described. A profile of a user and content information associated with a selected content file are retrieved in response to a selection input command from the user, the selection input command selecting the content file for transmission to the user. A play sequence of the content file is further selected based on the user profile and the content information. Finally, the selected play sequence is presented to the user.

Other features and advantages of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIG. 1 is a block diagram of one embodiment for an audio/video broadcast system architecture.

FIG. 2 is a block diagram of one embodiment for a content file having multiple content segments.

FIG. 3 is a block diagram of one embodiment for a selection device within the audio/video broadcast system.

FIG. 4 is a timing diagram of one embodiment for a method for interactive selection of a play sequence of a content file based on user profile and explicit input from a user.

FIG. 5 is a flow diagram of one embodiment for the method for interactive selection of a play sequence of a content file based on user profile and explicit input from a user.

### DETAILED DESCRIPTION

According to embodiments described herein, interactive decision-making scenarios in an audio/video broadcast are described.

In the following detailed description of embodiments of the invention, reference is made to the accompanying drawings in which like references indicate similar elements, and in which are shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

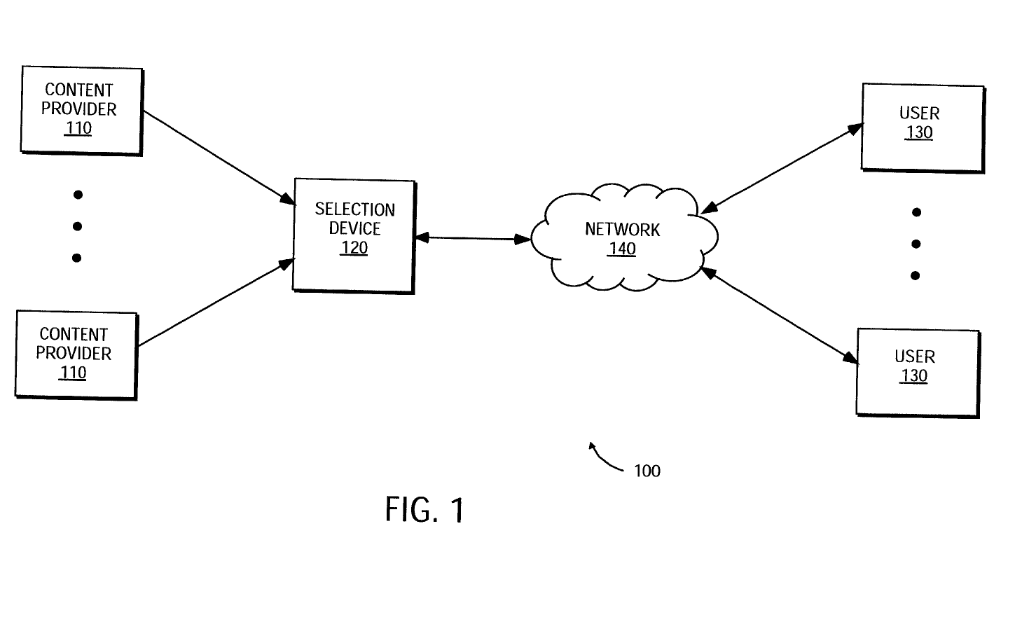

FIG. 1 is a block diagram of one embodiment for an audio/video broadcast system architecture. Referring to FIG. 1, the block diagram illustrates the environment in which the present invention operates. In the audio/video broadcast system architecture 100, multiple content providers 110, for example audio/video broadcasters, such as television networks and/or cable channel providers, are coupled to a selection device 120. Content providers 110 transmit content files, for example audio/video data, such as television or cable channel programs or advertisements, to the selection device 120. In one embodiment, selection device 120 stores the content files and communicates with one or more users 130 through a network 140 to present the content files upon requests received from users 130.

In one embodiment, network 140 is a local area network (LAN). Users 130 communicate with each other through the network 140 and communicate with selection device 120 directly or through a gateway computer system (not shown). In one embodiment, users 130 receive content files stored in the selection device 120 upon transmitting a request to the selection device 120. Alternatively, users 130 may act as content providers and may transmit content information, such as content files, to the selection device 120 for storage. The stored content information transmitted by any user 130 may then be shared with other users 130 via LAN 140.

In an alternate embodiment, network 140 may be a wide-area network (WAN). Wide-area network 140 includes the Internet, specifically the World Wide Web, or other proprietary networks, such as America Online™, CompuServe™, Microsoft Network™, and/or Prodigy™, each of which are well known to those of ordinary skill in the art. Wide-area network 140 may also include conventional network backbones, long-haul telephone lines, Internet service providers, various levels of network routers, and other conventional means for routing data between devices. Using conventional network protocols, selection device 120 may communicate through wide-area network 140 with multiple users 130, possibly connected through wide-area network 140 in various ways or directly connected to selection device 120. For example, as shown in the embodiment of FIG. 1, users 130 are connected directly to wide-area network 140 through a digital broadband connection, or a direct or dial-up telephone connection or other network transmission line. Alternatively, users 130 may be connected to wide-area network 140 through a conventional modem pool (not shown) or other type of connection.

In one embodiment, multiple users 130 may also be interconnected using the wide-area network 140 and may communicate with each other through the wide-area network 140. If the World Wide Web portion of the Internet is used as wide-area network 140, users 130 may communicate across the World Wide Web using the Hyper Text Transfer Protocol (HTTP) and the Hyper Text Markup Language (HTML). In this configuration, users 130 use an application program known as a web browser, for example the Netscape Navigator™ browser, published by America Online™, the Internet Explorer™ browser, published by Microsoft Corporation of Redmond, Wash., the user interface of America Online™, or the web browser or HTML translator of any other conventional supplier. Conventional means exist by which users 130 may supply information to selection device 120 through the wide-area network 140 and the selection device 120 may return information to users 130.

In one embodiment, content files from each content provider 110 are transmitted continuously and are selectively stored within selection device 120. Alternatively, content files may be transmitted at predetermined intervals from one or more content providers 110. In one embodiment, content files are stored within selection device 120 based on user profiles associated with each user 130, which are also stored in the selection device 120. In one embodiment, user profiles are sets of rules describing the viewing preferences of each user 130, for example subjects or areas of interest, favorite characters, shows, or motion pictures, as well as consumer interests for advertising purposes. Content files will be described in further detail below.

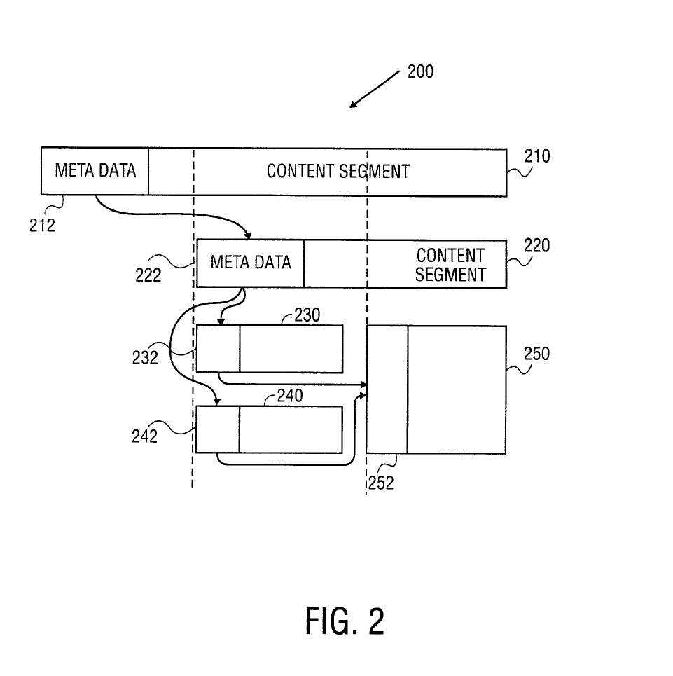

FIG. 2 is a block diagram of one embodiment for a content file having multiple content segments. As illustrated in FIG. 2, content file 200 includes multiple content segments 210 through 250, each content segment having associated content segment information, for example metadata 212 through 252, respectively. In one embodiment, each content segment 210 through 250 includes audio/video data to be presented to users 130, for example broadcasted programs and advertisements.

In one embodiment, each metadata 212 through 252 includes content information about its respective associated content segment 210 through 250, for example a description of the corresponding content segment, news information, and promotional information directed to users 130. In one embodiment, metadata 212 through 252 are linked together and further contain information about each other. The linked metadata 212-252 are configured to specify one or more play sequences for the content file 200, each play sequence incorporating a number of content segments 210-250 in a predetermined order.

In one embodiment, content file 200 is a broadcasted program, for example a motion picture, having alternate story lines. Each content segment 210-250 contains one alternate story line. In one embodiment, content segment 210 contains the main story line and metadata 212 contains information about the main story line. In one embodiment, each content segment 220 through 250 contains a story line alternate to the main story line stored within content segment 210. In one embodiment, metadata 212 is linked to metadata 222, which in turn is linked to metadata 232 and 242. At the same time, metadata 232 and 242 are both linked to metadata 252.

In one embodiment, a play sequence for content file 200, starting with content segment 210, which represents the main story line, is presented to users 130. The play sequence including content segment 210 is presented in uninterrupted form to users 130. Alternatively, the play sequence may change based on the profiles of users 130 or explicit inputs received from users 130.

In one embodiment, after a predetermined period of time, the play sequence is modified to include the presentation of an alternate story line contained within content segments 220, 230, or 240. Based on a profile of a user 130 receiving the play sequence or based on an input received from the user 130, since metadata 212 is linked to metadata 222, the play sequence is modified accordingly to present content segment 220 to the user 130. Alternatively, the presentation may switch to one of content segments 230 or 240.

After another predetermined period of time, the play sequence transmitted may change again and a new play sequence including content segment 250 may be presented to the user 130.

In an alternate embodiment, content file 200 further includes advertisements directed to a user 130. In one embodiment, the advertisements within content file 200 are presented to the user 130 based on the corresponding user profile. Considering the consumer interests of the user 130 stored in the user profile, selection device 120 presents targeted advertisements to user 130. Alternatively, the advertisements may be presented to user 130 based on explicit inputs, for example explicit input commands, received from user 130. User 130 prompts selection device 120 to present one or more specific advertisements. Selection device 120 receives the request and supplies only advertisements that match the user's request.

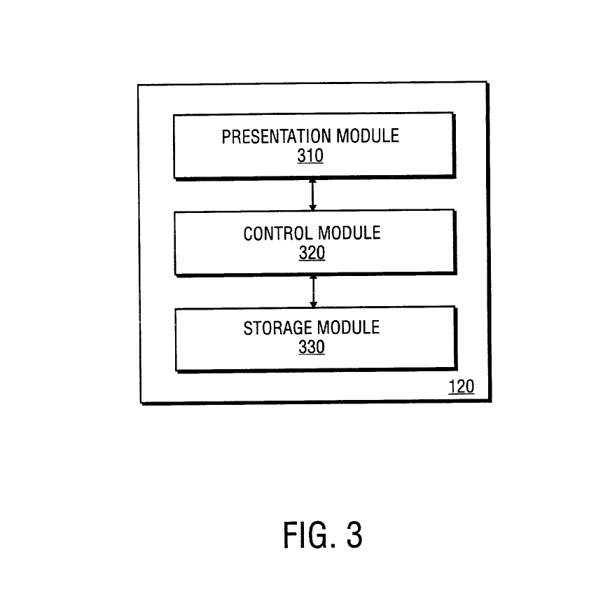

FIG. 3 is a block diagram of one embodiment for a selection device within the audio/video broadcast system. As illustrated in FIG. 3, selection device 120 includes a storage module 330, which stores content files 200 broadcasted by content providers 110 or transmitted by users 130, and user profiles of users 130, for example implicit user profiles, each implicit user profile including information regarding viewing habits of users 130, for example subjects and areas of interest, previous programs viewed by a user 130, and/or favorite advertising subjects. In one embodiment, storage module 330 further includes a content storage area, which stores the content files 200, and a profile storage area, which stores the implicit user profiles.

In one embodiment, selection device 120 further includes a control module 320 coupled to the storage module 330. The control module 320 retrieves selected content files 200 stored in the content storage area of the storage module 330 in response to selection input commands from users 130, and selects predetermined play sequences of each selected content file 200 based on the implicit user profiles of users 130 and further selection input commands received from users 130. In one embodiment, selection device 120 further includes a presentation module 310 coupled to control module 320 for presenting the play sequences and advertising material to users 130.

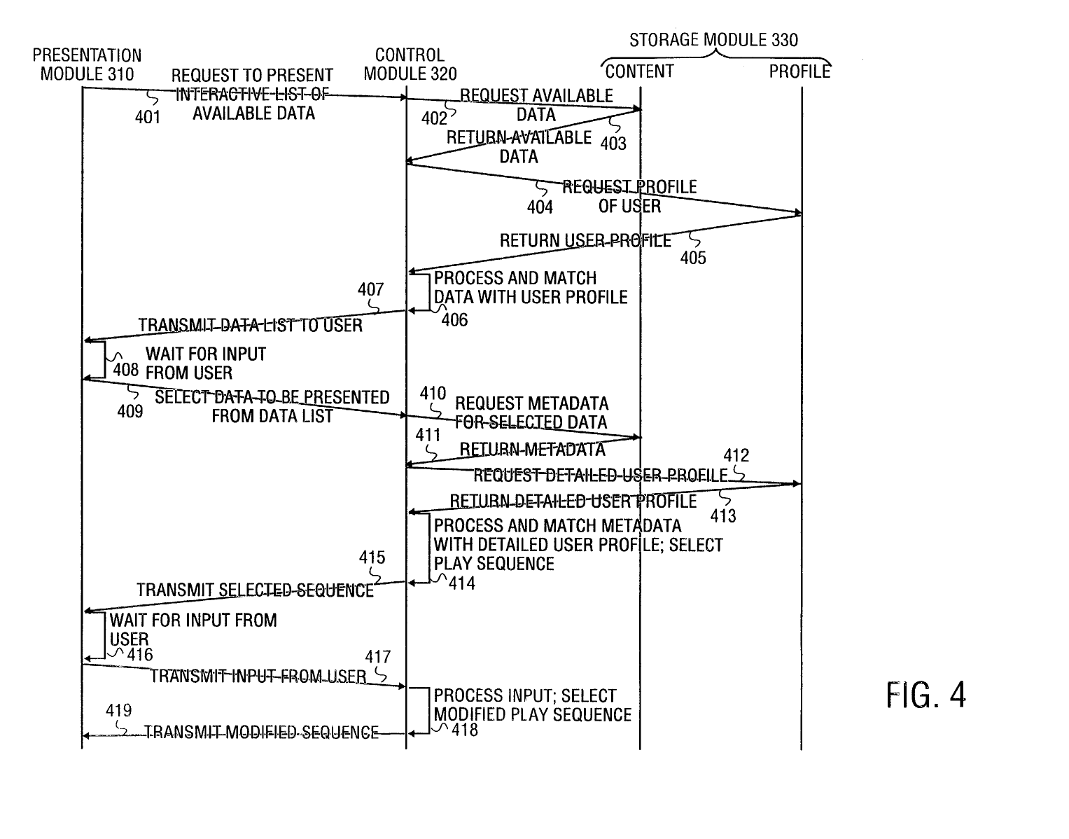

FIG. 4 is a timing diagram of one embodiment for a method for interactive selection of a play sequence of a content file based on user profile and explicit input from a user. As illustrated in FIG. 4, at state 401, a request to present an interactive list of available data is transmitted from presentation module 310 to control module 320. In one embodiment, user 130 transmits the request to retrieve an interactive list of content files 200 to the presentation module 310 within selection module 120. Presentation module 310 contacts the control module 320 and requests the interactive list of content files 200.

At state 402, a request to retrieve available data is transmitted to the storage module 330. In one embodiment, control module 320 forwards the request to retrieve available content files 200 to the content storage area of the storage module 330.

At state 403, storage module 330 returns available data to control module 320. In one embodiment, the content storage area of the storage module 330 returns the content files 200 stored within the storage module 330 and available for presentation to control module 320.

At state 404, a request to retrieve the profile of user 130 is transmitted to the storage module 330. In one embodiment, control module 320 transmits the request to retrieve the implicit user profile of user 130 to the profile storage area of storage module 330.

At state 405, storage module 330 returns the user profile of user 130 to the control module 320. In one embodiment, the profile storage area of storage module 330 receives the request and returns the user profile to control module 320. In one embodiment, the implicit user profile includes categories of programs and advertisements most watched by user 130. Alternatively, the implicit user profile may include other information enabling control module 320 to compile the interactive list of content files 200.

At state 406, control module 320 processes the available data and matches the data with the user profile of user 130 to create the interactive data list. In one embodiment, control module 320 matches the content files 200 received from storage module 330 with the stored user profile and creates the interactive list of content files 200 to be presented to user 130.

At state 407, the interactive data list is transmitted to the presentation module 310. In one embodiment, control module 320 transmits the interactive list of content files 200 to the presentation module 310.

At state 408, presentation module 310 presents the interactive data list to user 130 and waits for a selection input command from the user 130. In one embodiment, the interactive data list contains interactive menu selections, which allow user 130 to select a content file 200 from the list of content files presented.

At state 409, after user 130 selects data from the interactive data list, presentation module 310 transmits the selection input command to control module 320 for further processing.

At state 410, a request to retrieve metadata associated with the selected data is transmitted to the storage module 330. In one embodiment, control module 320 requests metadata 212-252 associated with the selected content file 200 from the content storage area of the storage module 330. In one embodiment, metadata 212 contains information pertaining to content segment 210 within the selected content file 200. Metadata 212 also contains links to other metadata 222-252 associated with respective content segments 220-250 within content file 200.

At state 411, metadata is returned to the control module 320. In one embodiment, the content storage area of the storage module 330 transmits metadata 212-252 to the control module 320.

At state 412, a request to retrieve a detailed user profile of user 130 is transmitted to the storage module 330. In one embodiment, control module requests the detailed user profile from the profile storage area of the storage module 330. In one embodiment, the detailed user profile includes detailed information about past viewing habits of user 130, for example frequently watched programs and advertisements and the user's favorite types of programming. Alternatively, the detailed user profile may include other information pertaining to the user 130.

At state 413, the detailed user profile is returned to the control module 320. In one embodiment, the profile storage area of the storage module 330 transmits the detailed user profile to the control module 320 for further processing.

At state 414, control module 320 processes and matches the metadata corresponding to the selected data with the detailed user profile to select a play sequence of the selected data. In one embodiment, control module 320 processes metadata 212-252 associated with the selected content file 200 and selects a play sequence of the content segments 210-250 within the selected content file 200 based on the detailed user profile of the user 130. At the same time, control module processes metadata 212-252 to select advertisements compatible with the detailed user profile of user 130.

At state 415, the selected play sequence is transmitted to the presentation module 310. In one embodiment, control module 320 transmits the selected play sequence to be presented to user 130. In one embodiment, the selected play sequence includes one or more of the content segments 210 through 250 in a predetermined order dictated by metadata 212. Alternatively, control module 320 also transmits advertising material together with the selected play sequence, for example the advertisements selected by control module 320 based on the detailed user profile of user 130.

At state 416, presentation module 310 waits for explicit input from user 130, while presenting the selected content file 200 in the selected play sequence to the user 130.

At state 417, an input from user 130 is transmitted to control module 320. In one embodiment, user 130 decides to change the selected play sequence of the content file 200 and requests a modified play sequence using interactive menu selections provided by presentation module 310. Presentation module 310 receives the explicit input command from user 130 requesting the modified play sequence and transmits the explicit input command to the control module 320. In an alternate embodiment, user 130 may also use the explicit input command to request specific advertisements using the interactive menu selections.

At state 418, the input is processed and a modified play sequence is selected. In one embodiment, control module 320 processes the explicit input command received from presentation module 310 and selects the modified play sequence. In one embodiment, the modified play sequence includes one or more of content segments 210 through 250 in an order specified by the explicit input signal. In an alternate embodiment, control module 320 also selects the specific advertisements requested by user 130.

Finally, at state 419, control module 320 transmits the modified play sequence of the content file 200 to the presentation module 310. In addition, if requested by user 130, control module also transmits the requested advertisements. Presentation module 310 then presents the modified play sequence and requested advertisements to user 130.

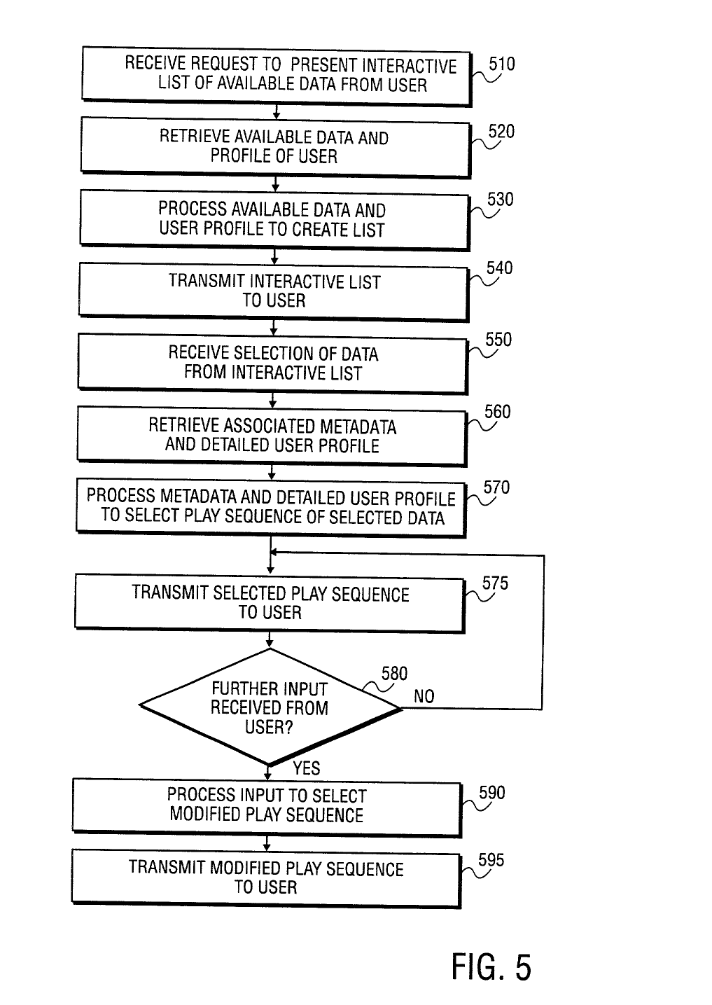

FIG. 5 is a flow diagram of one embodiment for the method for interactive selection of a play sequence of a content file based on user profile and explicit input from a user. As illustrated in FIG. 5, at processing block 510, a request to present an interactive list of available data is received from a user 130. In one embodiment, the presentation module 310 receives the request and forwards the request to control module 320.

At processing block 520, available data and a profile of user 130 are retrieved. In one embodiment, control module 320 communicates with storage module 330 and retrieves the stored content files 200 from the content storage area and the implicit user profile from the profile storage area of the storage module 330.

At processing block 530, available data and the user profile are processed to create a list for user 130. In one embodiment, control module 320 processes the retrieved content files 200 and the user profile to create an interactive list of content files 200 that match the user profile.

At processing block 540, the interactive list is transmitted to the user 130. In one embodiment, control module 320 transmits the interactive list of available content files 200 to the presentation module 310, which further presents the list to the user 130 along with interactive menu selections.

At processing block 550, a selection of data from the interactive list is received. In one embodiment, presentation module 310 receives a selection input command from user 130, which selects a content file 200 from the interactive list. Presentation module 310 further transmits the selection input command to control module 320 for further processing.

At processing block 560, metadata associated with the selected data and a detailed user profile of user 130 are retrieved. In one embodiment, control module 320 communicates with storage module 330 and retrieves metadata associated with the selected content file 200 from the content storage area of the storage module 330 and the detailed user profile from the profile storage area of the storage module 330.

At processing block 570, the retrieved metadata and the detailed user profile are processed to select a play sequence of the selected data. In one embodiment, control module 320 processes and matches the metadata associated to the selected content file 200 with the detailed user profile to create the play sequence of content segments 210-250 within the selected content file 200. Alternatively, in addition to creating the play sequence, control module 320 also processes metadata to select advertisements to be presented to user 130.

At processing block 575, the selected play sequence is transmitted to user 130. In one embodiment, control module 320 transmits the selected play sequence to the presentation module 310. Presentation module 310 presents the play sequence to the user 130 and waits for explicit input from user 130. Alternatively, in addition to the play sequence, selected advertisements are also presented to user 130.

At processing block 580, a decision is made whether further input is received from user 130. In one embodiment, if no further input is received from user, presentation module 310 continues to present the selected play sequence to user 130 and block 575 is repeated.

Otherwise, if an explicit input is received from user 130, at processing block 590, the input is processed to select a modified play sequence. In one embodiment, presentation module 310 receives the explicit input command from user 130 and transmits the input command to the control module 320. Control module 320 processes the explicit input command and creates the modified play sequence of content segments 210-250 within the selected content file 200. Alternatively, the explicit input command may also contain a request to present specific advertisements in addition to the modified play sequence. Control module 320 processes the explicit input command to select the requested advertisements.

Finally, at processing block 595, the modified play sequence is transmitted to user 130. In one embodiment, control module 320 transmits the modified play sequence to the presentation module 310, which further presents the modified play sequence to the user 130. Alternatively, in addition to the modified play sequence, control module 320 may also transmit the requested advertisements to the presentation module 310, which in turn presents them to user 130.

It is to be understood that embodiments of this invention may be used as or to support software programs executed upon some form of processing core (such as the CPU of a computer) or otherwise implemented or realized upon or within a machine or computer readable medium. A machine readable medium includes any mechanism for storing or transmitting information in a form readable by a machine (e.g., a computer). For example, a machine readable medium includes read-only memory (ROM); random access memory (RAM); magnetic disk storage media; optical storage media; flash memory devices; electrical, optical, acoustical or other form of propagated signals (e.g., carrier waves, infrared signals, digital signals, etc.); or any other type of media suitable for storing or transmitting information.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A method comprising:
retrieving a profile of a user and content information associated with a selected content file in response to a selection input command from said user, said selection input command selecting said selected content file for presentation to said user;
selecting a play sequence of said selected content file based on said profile and said content information; and
presenting said play sequence to said user.

2. The method according to claim 1, further comprising:
receiving an explicit input command from said user, said explicit input command requesting a change in said play sequence of said selected content file;
selecting a modified play sequence of said selected content file based on said explicit input command; and
presenting said modified play sequence to said user.

3. The method according to claim 1, further comprising:
retrieving said profile of said user and a plurality of content files including said selected content file;
selecting at least one content file of said plurality of content files based on said profile of said user; and
presenting a list containing said at least one content file to said user.

4. The method according to claim 1, wherein said selected content file further comprises audio/video data.

5. The method according to claim 1, wherein said content information associated with said selected content file further comprises a description of said selected content file and news related to said selected content file.

6. The method according to claim 1, wherein said selected content file further comprises a plurality of content segments, each content segment of said plurality of content segments having associated segment information within said content information.

7. The method according to claim 6, wherein said selecting further comprises:
processing said segment information of said each content segment and said profile of said user to match said segment information with said profile; and
selecting a predetermined number of content segments from said plurality of content segments in a predetermined order to form said play sequence.

8. The method according to claim 2, wherein said play sequence further comprises a predetermined number of content segments of said selected content file in a predetermined order and said modified play sequence further comprises said predetermined number of content segments in a modified order requested by said explicit input command.

9. The method according to claim 1, further comprising:
selecting advertising material based on said profile of said user; and
presenting said advertising material to said user together with said play sequence of said selected content file.

10. The method according to claim 2, wherein said explicit input command further requests presentation of at least one advertisement to said user.

11. The method according to claim 10, further comprising:
selecting said at least one advertisement based on said explicit input command; and
presenting said at least one advertisement to said user.

12. An apparatus comprising:
a control module to retrieve a profile of a user and content information associated with a selected content file in response to a selection input command from said user, said selection input command selecting said selected content file for transmission to said user, and to select a play sequence of said selected content file based on said profile and said content information; and
a presentation module to present said play sequence to said user.

13. The apparatus according to claim 12, further comprising a storage module to store said profile of said user and a plurality of content files including said selected content file.

14. The apparatus according to claim 12, wherein said control module further receives an explicit input command from said user, said explicit input command requesting a change in said play sequence of said selected content file, and further selects a modified play sequence of said selected content file based on said explicit input command.

15. The apparatus according to claim 14, wherein said presentation module further presents said modified play sequence to said user.

16. The apparatus according to claim 13, wherein said control module further retrieves said profile of said user and said plurality of content files from said storage module and selects at least one content file of said plurality of content files based on said profile of said user.

17. The apparatus according to claim 16, wherein said presentation module further presents a list containing said at least one content file to said user.

18. The apparatus according to claim 12, wherein said selected content file further comprises audio/video data.

19. The apparatus according to claim 12, wherein said content information associated with said selected content file further comprises a description of said selected content file and news related to said selected content file.

20. The apparatus according to claim 12, wherein said selected content file further comprises a plurality of content segments, each content segment of said plurality of content segments having associated segment information within said content information.

21. The apparatus according to claim 20, wherein said control module further processes said segment information of said each content segment and said profile of said user to match said segment information with said profile, and selects a predetermined number of content segments from said plurality of content segments in a predetermined order to form said play sequence.

22. The apparatus according to claim 14, wherein said play sequence further comprises a predetermined number of content segments of said selected content file in a predetermined order and said modified play sequence further comprises said predetermined number of content segments in a modified order requested by said explicit input command.

23. The apparatus according to claim 12, wherein said control module further selects advertising material based on said profile of said user and said presentation module further presents said advertising material to said user together with said play sequence of said selected content file.

24. The apparatus according to claim 13, wherein said profile of said user is stored in a profile storage area of said storage module.

25. The apparatus according to claim 13, wherein said plurality of content files is stored in a content storage area of said storage module.

26. The apparatus according to claim 14, wherein said explicit input command further requests presentation of at least one advertisement to said user.

27. The apparatus according to claim 26, wherein said control module further selects said at least one advertisement based on said explicit input command and said presentation module further presents said at least one advertisement to said user.

28. A computer readable medium containing executable instructions which, when executed in a processing system, cause the system to perform a method comprising:
retrieving a profile of a user and content information associated with a selected content file in response to a selection input command from said user, said selection input command selecting said selected content file for presentation to said user;
selecting a play sequence of said selected content file based on said profile and said content information; and
presenting said play sequence to said user.

29. The computer readable medium according to claim 28, wherein the method further comprises:
receiving an explicit input command from said user, said explicit input command requesting a change in said play sequence of said selected content file;
selecting a modified play sequence of said selected content file based on said explicit input command; and
presenting said modified play sequence to said user.

30. The computer readable medium according to claim 28, wherein the method further comprises:
retrieving said profile of said user and a plurality of content files including said selected content file;
selecting at least one content file of said plurality of content files based on said profile of said user; and
presenting a list containing said at least one content file to said user.

31. The computer readable medium according to claim 28, wherein said selected content file further comprises audio/video data.

32. The computer readable medium according to claim 28, wherein said content information associated with said selected content file further comprises a description of said selected content file and news related to said selected content file.

33. The computer readable medium according to claim 28, wherein said selected content file further comprises a plurality of content segments, each content segment of said plurality of content segments having associated segment information within said content information.

34. The computer readable medium according to claim 33, wherein said selecting further comprises:
processing said segment information of said each content segment and said profile of said user to match said segment information with said profile; and
selecting a predetermined number of content segments from said plurality of content segments in a predetermined order to form said play sequence.

35. The computer readable medium according to claim 29, wherein said play sequence further comprises a predetermined number of content segments of said selected content file in a predetermined order and said modified play sequence further comprises said predetermined number of content segments in a modified order requested by said explicit input command.

36. The computer readable medium according to claim 28, wherein the method further comprises:
selecting advertising material based on said profile of said user; and
presenting said advertising material to said user together with said play sequence of said selected content file.

37. The computer readable medium according to claim 29, wherein said explicit input command further requests presentation of at least one advertisement to said user.

38. The computer readable medium according to claim 37, wherein the method further comprises:
selecting said at least one advertisement based on said explicit input command; and
presenting said at least one advertisement to said user.
